(19) United States
(12) Patent Application Publication
(10) Pub. No.: US 2003/0068202 A1
(43) Pub. Date: Apr. 10, 2003

(54) Heap and in-situ remediation of contaminated soil using metallic iron and hydrogen peroxide

(76) Inventors: Hsing Kuang Lin, Fairbanks, AK (US); Huan Vinh Luong, Seattle, WA (US)

Correspondence Address: Hsing Kuang Lin, 2143 Bridgewater Drive, Fairbanks, AK, 99709-4104, US

(21) Appl. No.: 09/971,215

(22) Filed: Oct. 3, 2001

(51) Int. Cl. B09C 1/08

(52) U.S. Cl. 405/128.5; 210/747; 405/128.75

(57) ABSTRACT

The present invention describes heap and in-situ remediation to treat soil contaminated with one or more halogenated organic compounds by reacting the soil with a combination of metallic iron and hydrogen peroxide.

### TECHNICAL FIELD OF THE INVENTION

The present invention relates in general to methods of decomposing organic compounds from soils contaminated therewith. The present invention relates in particular to methods decomposing phenol related organic compounds such as pentachlorophenol (PCP) from soils contaminated therewith using heap and in-situ remediation methods.

### DISCUSSION OF BACKGROUND ART

There are many sites in the United States and in other countries of the world where soils are contaminated with hazardous organic compounds. Many of these compounds, especially chlorinated organic compounds are toxic to human and some are carcinogens. One effective method of remediation for contaminated soils, approved by the United States Environmental Protection Agency, is based on high temperature incineration. High temperature incineration requires high energy consumption and is costly as a result. Further, as incineration facilities are in fixed location, transportation of the contaminated soils from the contaminated sites to the incineration facilities increases remediation cost.

An innovative method utilizing agitating reactor and a combination of metal and oxidant has been developed, and proven to be effective for decomposing pentachlorophenol (PCP) and polychlorinated biphenyls (PCBs) in contaminated soil (Luong and Lin, 1999, U.S. Pat. No. 5,855,797; Luong and Lin, 2000, Analytical letters, 33(14), PP 3051-3065). The present invention improves this technology to effectively apply it in heap and in-situ soil remediation. This invention utilizes a combination of a metal and an oxidant to perform in-situ and heap remediation of soils that are contaminated with hazardous organic compounds.

In-situ remediation has the advantage of treatment without excavating the contaminated soil. The present invention requires metals to be planted into the contaminated soil or spread on top of the contaminated soil. Then, the oxidant-containing solution is sprayed onto the metal-added contaminated soil. When the solution percolates through the contaminated in-situ soil formation, the hazardous organic compounds are decomposed.

Heap remediation requires excavating the contaminated soil and piling the soil onto an impermeable pad. The metal (s) is then mixed into the contaminated soil or spread on the top of the soil heap. The oxidant-containing solution is then sprayed onto the pile of the metal-added contaminated soil heap. When the solution percolates through the contaminated soil heap, the hazardous organic compounds are decomposed.

### SUMMARY OF INVENTION

The present invention is directed to methods for decomposing organic contaminants including pentachlorophenol and polychlorinated biphenyls from soils contaminated therewith.

One method of the present invention comprises the steps of adding a metal into the contaminated soil to form soil heap and spraying an oxidant-containing solution on the metal-added soil heap until essentially all of the contaminants in the soil have been decomposed by the reaction in which the metal and the oxidant are the active reactants. The essentially contaminant-free soil heap then can be sprayed with a pH neutralizing solution to render the pH of the contaminant-removed soil heap acceptable.

Another method of the present invention comprises the steps of “in-situ” adding of metal into the contaminated soil. Then “in-situ” spraying the oxidant-containing solution onto the metal-added soil formation until essentially all the contaminants in the soil formation have been decomposed. Neutralization of the treated soil with pH adjusting solution will then be done to render the pH of the treated soil acceptable. The combination of the metal and the oxidant reacts to decompose the contaminants. This method has the advantage of being an in-situ process, which eliminates the excavating cost.

A preferred oxidant is hydrogen peroxide. A preferred metal is metallic iron. In the reaction, the contaminants decompose into simple non-toxic fragments including water, carbon dioxide, and oxygen. Chloride irons from decomposed chlorinated organic compounds will remain in remediated water, but will be within non-hazardous concentrations (for example, less than would be found in chlorine-treated domestic water supplies).

### BRIEF DESCRIPTIONS OF THE INVENTION

The accompanying drawings, which are incorporated in and constitute a part of the specification, schematically illustrate preferred embodiments of the invention and, together with the general description given above and the detailed description of the preferred embodiments given below, serve to explain the principles of the invention.

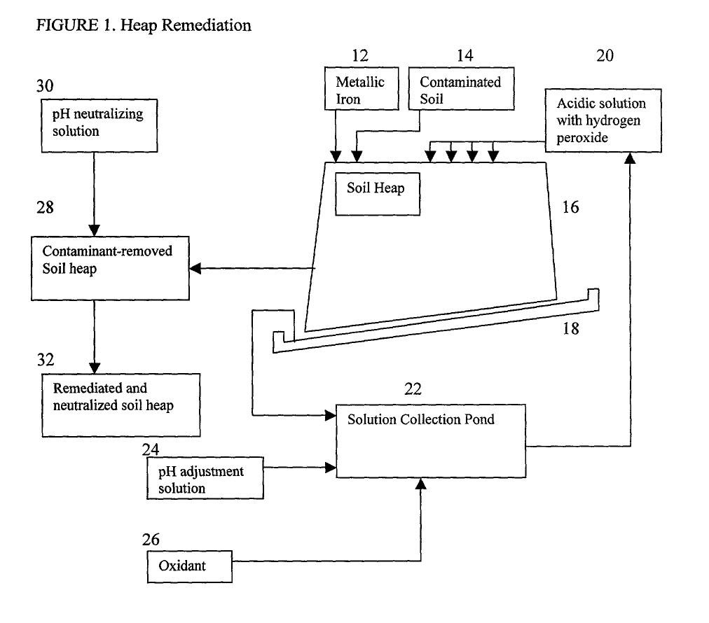

FIG. 1 is a flow chart schematically illustrating one preferred embodiment of the heap remediation method of the present invention for remediating contaminated soils.

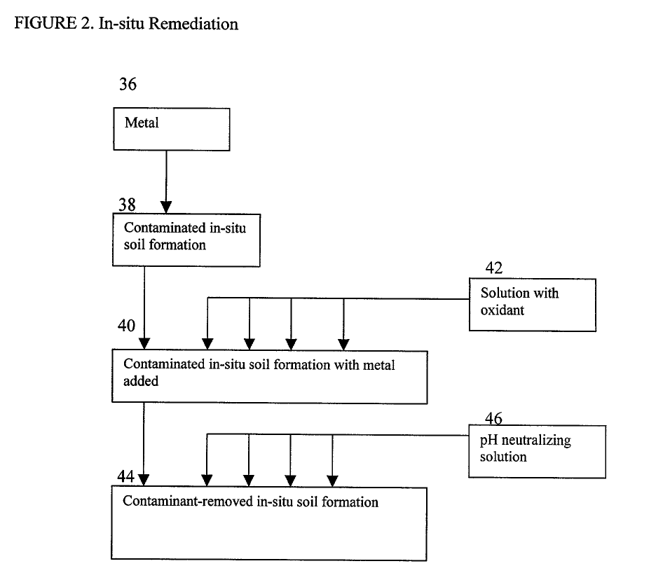

FIG. 2 is a flow chart schematically illustrating one preferred embodiment of the in-situ remediation method of the present invention for remediating contaminated soils.

### DETAILED DESCRIPTION OF THE INVENTION

Referring now to FIG. 1, the figure illustrates a preferred embodiment of heap remediation method of the present invention for remediating soil contaminated with pentachlophenol, polychlorinated biphenyls or other chlorinated organic compounds. Metal scrap or powder (box 12) is added to the contaminated soil (box 14) to form a soil heap (box 16), which piles onto an impermeable pad (box 18). The preferred metal is iron. The use of other metals or combination of more than one different metals, however is not precluded. The metal is preferably mixed evenly with the contaminated soil, although the metal can be simply spread on the top of the contaminated soil piles with less effective remediation. The mixing of the metal with the contaminated soil can occur during the transportation of the soil to the heap by conveyer belts or trucks or during construction of the heap. The dimensions of the soil heap may be limited by the topography of the site where the soil heap is built but not limited by the present invention. The heap is usually built adjacent to the contaminated site to save the transportation cost.

Solution containing oxidant for decomposing the contaminants (box 20) is then sprayed onto the soil heap (box 16) to decompose the contaminants in the soil heap (box 16) as the solution percolates through the soil heap. The spraying of the oxidant-containing solution continues until essentially all the contaminants in the soil have been decomposed. The term “essentially all contaminants” here, and throughout this description and the appended claims, means that any remaining concentrations of the contaminants will be below hazardous levels. The solution (box 20) preferably has a pH less than 7.0. A preferred oxidant is hydrogen peroxide. Hydrogen peroxide has the advantage of producing no toxic by-products. The use of other oxidants or a combination of more than one different oxidants including hydrogen peroxide is not precluded.

The impermeable pad (box 18) can be made of geotechnical materials or other materials. The impermeable pad can be prepared in such a way with a moderate slope that when the solution percolates through the soil heap and reaches the bottom of the soil heap, the solution can be easily directed to a solution collection pond (box 22). The solution in the solution collection pond (with pH adjustment (box 24) and oxidant addition (box 26)) can be reused as the oxidant-containing solution (box 20).

The contaminant-removed soil heap (box 28) may contain residual solution of an undesired pH. Solution for neutralizing the contaminant-removed soil heap can be used to rinse the contaminant-removed soil heap (box 30). Lime or limestone solution is the preferred solution for neutralizing the contaminant-removed soil heap to render the pH value of the residual solution in the contaminant-removed soil heap acceptable. The contaminant-removed and neutralized soil heap (box 32) is clean and can be put back to the site.

Referring now to FIG. 2, the figure illustrates a preferred embodiment of in-situ remediation method of the present invention for remediating soil contaminated by pentachlophenol, polychlorinated biphenyls or other chlorinated organic compounds. While the contaminated soil formation (box 38) does not require excavation, metal is added to the contaminated soil formation. Metal scrap, metal powder, or other metal forms can be planted into the contaminated soil formation by tilling or other planting methods. The metal, in forms of scrap, powder or other forms can also be spread onto the top of the contaminated soil formation, with less efficiency of remediation. The preferred metal is iron. The use of other metals or combination of more than one different metals, however is not precluded. After the metal is added to the contaminated soil formation (box 40), the solution with oxidant for decomposing the contaminants (box 42) can be sprayed onto the contaminated soil formation. As the oxidant-containing solution percolates through the soil formation, the contaminants will be decomposed. The solution (box 42) preferably has a pH less than 7.0. A preferred oxidant is hydrogen peroxide. The use of other oxidants or a combination of more than one different oxidant including hydrogen peroxide is not precluded.

The contaminant-removed soil formation (box 44) with the contaminants decomposed, may contain solution with undesired pH, thus it may need to be neutralized. Solution for neutralizing the contaminant-removed soil formation (box 46) can be sprayed onto the contaminant-removed soil formation until the pH of the soil reaches an acceptable value. Lime or limestone solution is the preferred solution for the neutralizing the contaminant-removed soil formation to render the pH value of the residual solution in the contaminant-removed soil formation to be acceptable.

During the process of in-situ remediation of the present invention, the soil is not excavated and remains at the original site.

The chemistry of destruction of PCP and PCBs by a combination of metallic iron and hydrogen peroxide has been demonstrated to be very effective using an agitating reactor while metallic iron or hydrogen peroxide alone is ineffective. (Luong and Lin, 1999, U.S. Pat. No. 5,855,797). To simulate the heap and in-situ remediation, experiments were conducted in glass columns. TABLE 1 presents results of tests on a contaminated soil containing 132 parts per million (PPM) of PCP, with different reagents. The experiments of TABLE 1 were carried out in glass columns of 1.5 inch in diameter and 24 inches in length. Solid chemicals (metallic iron or ferrous sulfate powder) were mixed with the contaminated soil before the soil was loaded into the column reactor. Solution of 23° C. was pumped into the top of the soil bed in the column reactor. Effluent was discharged from the bottom of the soil bed in the column reactor through a valve. Percolation rate of the solution was controlled at about 0.35 liter per square meter per minute.

TABLE 1

| | | | Reaction | % PCP |
|---|---|---|---|---|
| Test No. | Reagents | Solution pH | Time | Destruction |
| 1 | 3.0% H₂O₂ | 2.0 | 24 hr | Less than 2 |
| 2 | 2.8% of ferrous | 2.0 | 24 hr | Less than 2 |
| | sulfate powder | | | |
| | in the soil, | | | |
| | 3.0% H₂O₂ | | | |
| | solution | | | |
| 3 | 1.0% of | 2.0 | 24 hr | Less than 2 |
| | metallic iron | | | |
| | powder in the | | | |
| | soil | | | |
| 4 | 1.0% of | 2.0 | 24 hr | 32 |
| | metallic iron | | | |
| | powder in the | | | |
| | soil, 3.0% H₂O₂ | | | |
| | solution | | | |
| 5 | 1.0% of | 2.0 | 48 hr | 41 |
| | metallic iron | | | |
| | powder in the | | | |
| | soil, 3.0% H₂O₂ | | | |
| | solution | | | |
| 6 | 1.0% of | 1.8 | 48 hr | 52 |
| | metallic iron | | | |
| | powder in the | | | |
| | soil, 3.0% H₂O₂ | | | |
| | solution | | | |

Presented in TABLE 1, results of tests 1, 2 and 3 show that, in 24 hours, hydrogen peroxide alone, ferrous sulfate powder with hydrogen peroxide or metallic iron powder alone provided negligible PCP destruction. Shown in test 4, by mixing metallic iron powder of 1.0% of the weight of the soil with the soil, 32% of PCP was destroyed in 24 hours when the solution contained 3.0% hydrogen peroxide. By extending the time period to 48 hours under the same condition, the destruction of PCP increased to 41%, as shown in test 5. The PCP destruction can increase to 52%, in 48 hours of reaction time, by lowering the pH of the oxidant-containing solution to 1.8.

It is evident to one skilled in the art to which the present invention pertains that the degree of PCP destruction in the soil can be increased by adding higher concentrations of metallic iron and hydrogen peroxide, increasing the percolation rate of the solution, extending the reaction time or decreasing the pH of the solution with oxidant. It is estimated that when applied in a proper physical and chemical properties of the contaminated soil, the overall cost of the heap remediation or in-situ remediation will be a fraction of that of the agitating remediation described in a previous U.S. Patent (Luong and Lin, 1999, U.S. Pat. No. 5,855,797).

The pH of the effluent solution of the PCP destruction ranged from 2.5 to 4.3 in the tests. The contaminant-removed soil in the column reactor was then neutralized with a 2.0% lime solution at a similar percolation rate for 2.0 hours. The neutralization process brought the pH of the final effluent solution to a desirable pH range of 6.5 to 7.5.

During the reaction, the contaminants are decomposed into simple non-toxic fragments including water, carbon dioxide and oxygen. Chloride ions from decomposed chlorinated organic compounds will remain in remediated water, but will be presented in non-hazardous concentrations, for example, less than would be found in chlorine-treated domestic water supplies. Iron and the reaction product of iron oxide are non-toxic and can remain in the soil after the contaminants have been removed. The remaining iron can be recovered from the remediated soil by magnetic separation process.

In summary, methods of remediating soil contaminated with contaminants including pentachlorophenol (PCP) and polychlorinated biphenyls (PCBs) are described above. The essential features of the methods include adding reagent amount of iron metal, in elemental or alloy form, into soil heap or in-situ soil formation and followed by spraying solution of hydrogen peroxide onto the soil heap or in-situ soil formation until essentially all of the contaminants have been decomposed and soil is essentially free of the contaminants. The methods are usually applied at the ambient temperature and do not require reaction temperature greater than 80° C., and accordingly, do not require the high energy consumption of prior art incineration methods. While the methods of the present invention have been described in terms of preferred embodiments, the methods are not limited to those embodiments described and depicted. Rather, the invention is limited only by the claim appended hereto.

What is claimed is:

1. A method of removing contaminants including phenol related organic compounds from soil contaminated therewith, the method comprising the steps of:
(a) Adding a metal to the contaminated soil and to form a contaminated soil heap;
(b) Spraying a first, acidic aqueous solution containing an oxidant onto the metal-added contaminated soil heap until essentially all of the contaminants in the soil heap have been decomposed and forming a contaminant-removed soil heap; and
(c) Spraying a neutralizing solution to the contaminant-removed soil heap to render the soil heap a desirable pH.

2. The method of claim 1 wherein said acidic aqueous solution with pH<7.0 is made acidic by addition of an acid thereto.

3. The method of claim 1 wherein the amount of said metal added to the soil heap is selected in direct relationship to an anticipated level of the contaminants in the soil.

4. The method of claim 1 wherein the phenol related organic compounds include pentachlorophenol (PCP) and polychlorinated biphenyls (PCBs).

5. The method of claim 1 wherein said metal in a molar ratio greater than about 0.1 with said oxidant.

6. The method of claim 1 wherein said metal includes at least iron.

7. The method of claim 1 wherein said oxidant is hydrogen peroxide.

8. The method of claim 1 wherein said neutralizing solution is lime solution.

9. A method of removing contaminants including phenol related organic compounds from soil contaminated therewith, the method comprising the steps of
(a) Adding a metal, in elemental or alloy form, to the contaminated in-situ soil formation;
(b) Spraying a first, acidic aqueous solution containing an oxidant onto the metal-added contaminated in-situ soil formation until essentially all of the contaminants in the in-situ soil formation have been decomposed and forming a contaminant-removed in-situ soil formation; and
(c) Spraying a neutralizing solution to the contaminant-removed in-situ soil formation to render the contaminant-removed soil formation a desirable pH.

10. The method of claim 9 wherein said acidic aqueous solution is made acidic by addition of an acid thereto.

11. The method of claim 9 wherein the amount of said metal added to the soil heap is selected in direct relationship to an anticipated level of the contaminants in the soil.

12. The method of claim 9 wherein the phenol related organic compounds include pentachlorophenol (PCP) and polychlorinated biphenyls (PCBs).

13. The method of claim 9 wherein said metal is a molar ratio greater than about 0.1 with said oxidant.

14. The method of claim 9 wherein said metal includes at least iron.

15. The method of claim 9 wherein said oxidant is hydrogen peroxide.

16. The method of claim 9 wherein said neutralizing solution is lime solution.
